(19) United States
(12) Patent Application Publication
(10) Pub. No.: US 2015/0092447 A1
(43) Pub. Date: Apr. 2, 2015

(54) APPARATUS FOR COMPENSATING IMAGE OF DISPLAY AND DISPLAY ASSEMBLY

(71) Applicant: Ye Xin Technology Consulting Co., Ltd., Hsinchu (TW)

(72) Inventor: I-WEI WU, Hsinchu (TW)

(21) Appl. No.: 14/494,059

(22) Filed: Sep. 23, 2014

(30) Foreign Application Priority Data
Sep. 27, 2013 (TW) 102135211

(51) Int. Cl. F21V 8/00

(52) U.S. Cl. CPC G02B 6/0038
USPC 362/616

(57) ABSTRACT

An image compensating apparatus located on a display panel includes a light incident surface set on the display region, a light emitting surface parallel with the light incident surface, and a plurality of light guiding channels parallel with each other. The display panel includes a display region displaying an image and a non-display region encircling a periphery of the display region. The light guiding channel interconnects with the light incident surface and the light emitting surface, and angles with the light incident surface. When viewed from a direction perpendicular to the light incident surface, the light guiding channel moves an image displayed on the display region for a predetermined distance for covering at least partial of the non-display region.

### CROSS-REFERENCE TO RELATED APPLICATIONS

This application is related to U.S. patent application Ser. No. 14/164,118 filed on Jan. 24, 2014, entitled “DISPLAY DEVICE, JOINT DISPLAY AND BACKLIGHT MODULE”; U.S. patent application Ser. No. 14/164,139 filed on Jan. 25, 2014, entitled “APPARATUS FOR COMPENSATING IMAGE OF DISPLAY AND METHOD FOR MANUFACTURING SAME”; U.S. patent application Ser. No. 14/164,140 filed on Jan. 25, 2014, entitled “APPARATUS FOR COMPENSATING IMAGE OF DISPLAY AND METHOD FOR MANUFACTURING SAME”; U.S. patent application Ser. No. 14/164,136 filed on Jan. 25, 2014, entitled “APPARATUS FOR COMPENSATING IMAGE OF DISPLAY, DISPLAY AND JOINT DISPLAY”; and U.S. patent application Ser. No. 14/164,137 filed on Jan. 25, 2014, entitled “DISPLAY ELEMENT, DISPLAY DEVICE AND JOINT DISPLAY”. This application claims priority to Taiwan Patent Application No. 102135211 filed on Sep. 27, 2013 in the Taiwan Intellectual Property Office, the contents of which are incorporated by reference herein.

### FIELD

The present disclosure relates to an image compensating apparatus disposed upon a display panel.

### BACKGROUND

In order to obtain a display panel of a relative large size it may be manufactured by a large number of serialization displays jointed together in a plane. The borders between two adjacent display panels jointing together is un-visible.

### BRIEF DESCRIPTION OF THE FIGURES

Implementations of the present technology will now be described, by way of example only, with reference to the attached figures, wherein:

FIG. 1 is a partially exploded view of an embodiment of a display, the display including an image compensating apparatus.

FIG. 2 is an assembled isometric view of an embodiment of the display of FIG. 1.

FIG. 3 is a cross-sectional view of an embodiment of the display of FIG. 2, taken along a line III-III thereof, the display including a light guiding fiber.

FIG. 4 is an isometric view of an embodiment of the light guiding fiber of FIG. 3.

FIG. 5 is an isometric view of an embodiment of the compensating apparatus of FIG. 1.

FIG. 6 is a partially exploded view of another embodiment of the display.

FIG. 7 is an assembled isometric view of an embodiment of the display of FIG. 6.

FIG. 8 is a cross-sectional view of an embodiment of the display of FIG. 7, taken along a line VIII-VIII thereof.

FIG. 9 is a cross-sectional view of an embodiment of the display of FIG. 7, taken along a line IX-IX thereof.

FIG. 10 is an isometric view of a first embodiment of a display assembly jointed from two displays of FIG. 1.

FIG. 11 is a cross-sectional view of an embodiment of the display of FIG. 10, taken along a line XI-XI thereof

FIG. 12 is an isometric view of a second embodiment of the display assembly jointed from two displays of FIG. 1.

FIG. 13 is an isometric view of a third embodiment of a display assembly jointed from two displays of FIG. 2.

FIG. 14 is a partially exploded view of a fourth embodiment of a display assembly.

FIG. 15 is a cross-sectional view of an embodiment of the display assembly of FIG. 14.

FIG. 16 is a cross-sectional view of a fifth embodiment of a display assembly.

FIG. 17 is an isometric view of a sixth embodiment of a display assembly.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure is described in relation to a display with a zero border effect.

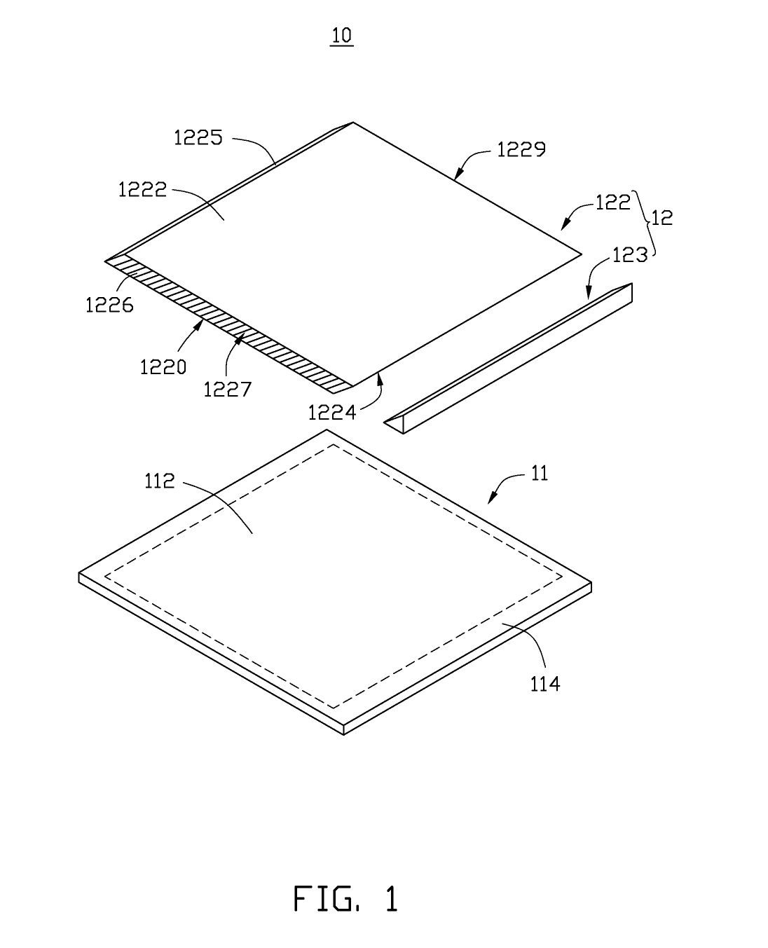

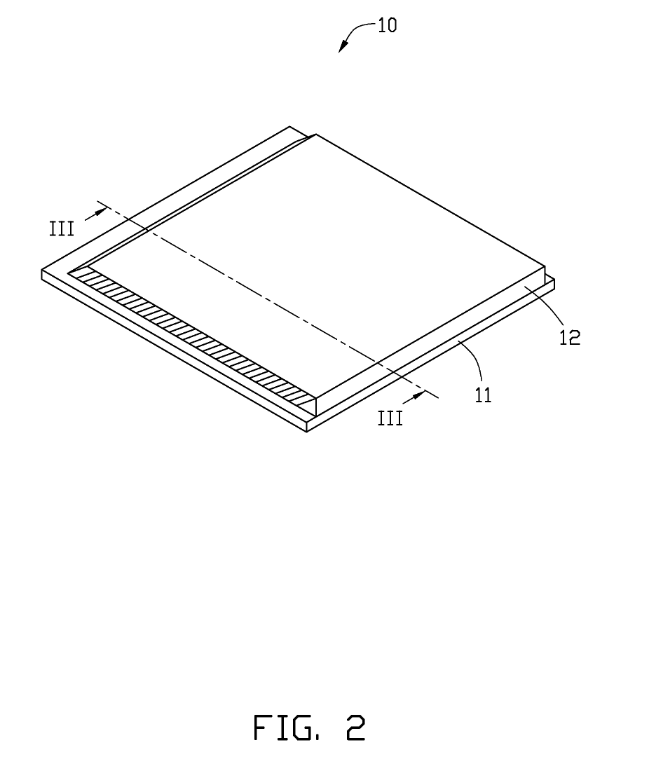

FIG. 1 illustrates an embodiment of a display 10. The display 10 includes a display panel 11 and an image compensating apparatus 12 located on the display panel 11 (as shown in FIG. 2). In at least one embodiment, the display panel 11 is a liquid crystal display (LCD) panel or an organic light emitting display (OLED) panel.

The display panel 11 includes a display region 112 and a non-display region 114 encircling a periphery of the display region 112. In at least one embodiment, the non-display region 114 is a frame of the display 10.

The image compensating apparatus 12 includes an image compensating portion 122 set on the display region 112 and a supporting portion 123 set on the non-display region 114. The image compensating portion 112 moves an image displayed on the display region 112 to project on the non-display region 114 for covering at least partial of the non-display region 114.

The image compensating portion 122 includes a light incident surface 1220 resisting with the display region 112, a light emitting surface 1222 parallel with the light incident surface 1220, and a plurality of light guiding channels 1226 parallel with each other. In at least one embodiment, the image compensating portion 122 is substantially parallelepiped.

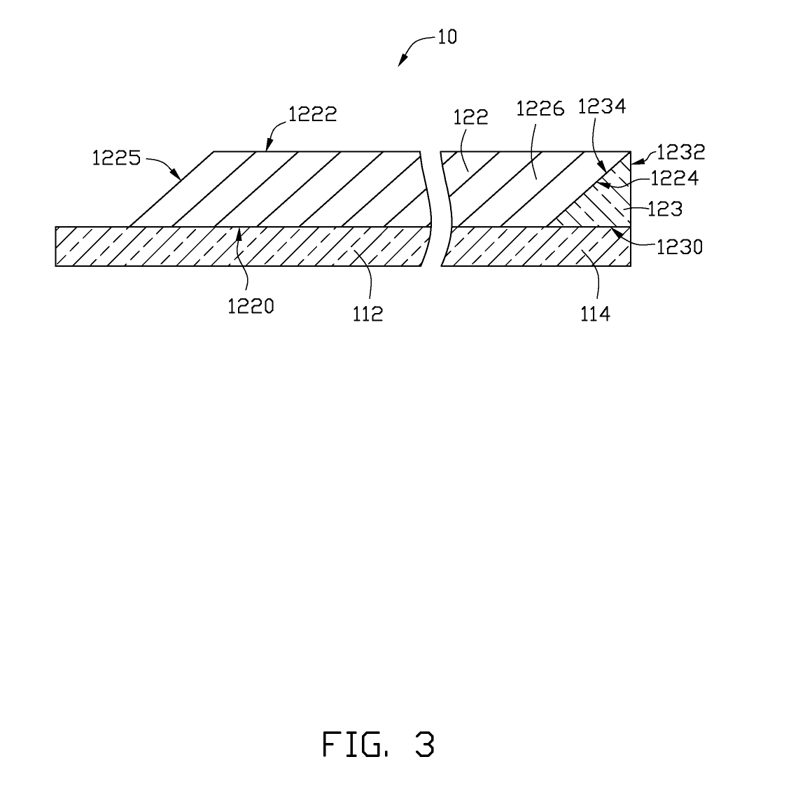

FIG. 3 illustrates that the image compensating portion 122 further includes a first inclined surface 1224, a second inclined surface 1225 opposite to the first inclined surface 1224, a first connecting surface 1227, and a second connecting surface 1229 opposite to the first connecting surface 1227. The first inclined surface 1224, the first connecting surface 1227, the second inclined surface 1225, and the second connecting surface 1229 are orderly extended from the four edges of the light incident surface 1220, and are interconnecting the light emitting surface 1222. The first inclined surface 1224 and the light incident surface 1220 may define an obtuse angle, which is within a range of 130 degrees to 150 degrees. The second inclined surface and the light incident surface 1220 may define an acute angle, which is within a range of 30 degrees to 50 degrees. The first connecting surface 1227 and the second connecting surface 1229 are perpendicular to the light incident surface 1220. In the at least one embodiment, the obtuse angle is 135 degrees. The first inclined surface 1224, the second inclined surface 1225, the first connecting surface 1227, and the second connecting surface 1229 are parallel with the predetermined direction.

Each of the light guiding channel 1226 extends from the light incident surface 1220 to the light emitting surface 1222 along a predetermined direction. Cross section areas of each of the light guiding channels 1226 are constant, which means diameter of each of the light guiding channels 1226 is constant. The light guiding channel 1226 and the light incident surface 1220 may be define an acute angle, which is within a range of 30 degrees to 50 degrees. In at least one embodiment, the predetermined direction is parallel with the first inclined surface 1224, the first connecting surface 1227, and the second connecting surface 1229.

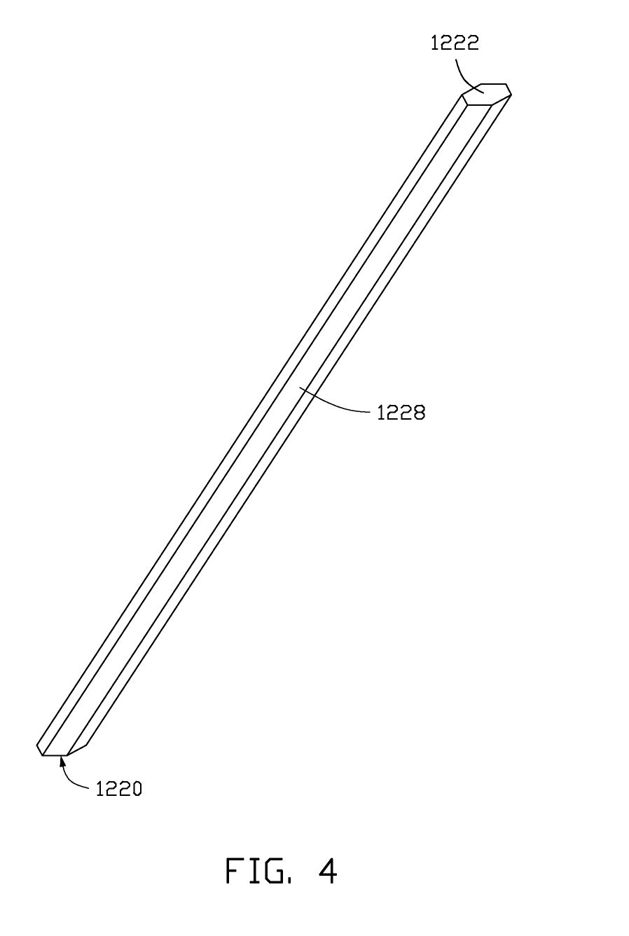

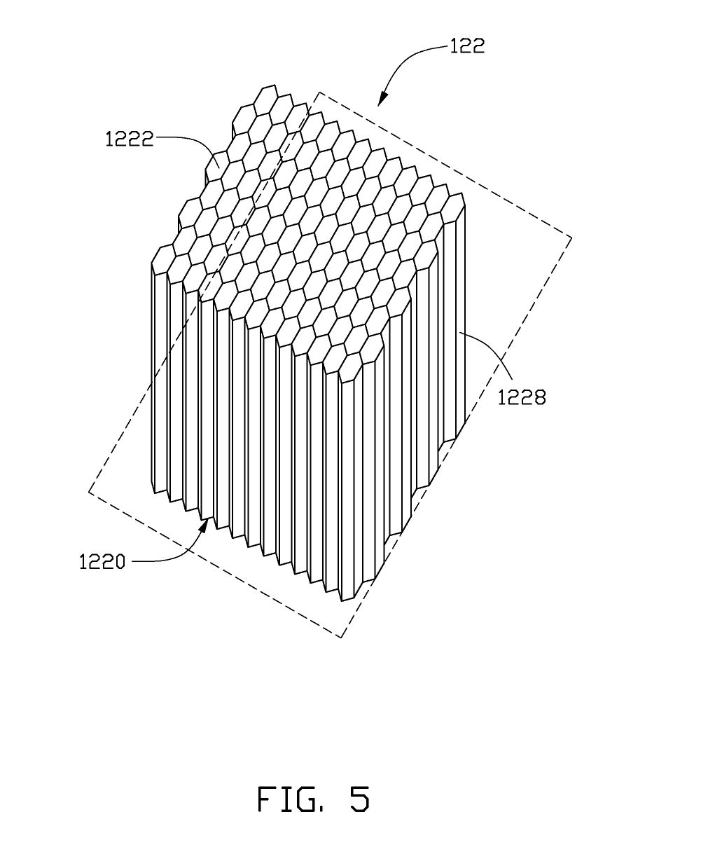

FIGS. 4 and 5 illustrates that the light guiding light channels 1226 are defined by a plurality of light guiding fiber 1228. The light guiding fibers 1228 orderly arranged in a parallelepiped bunch. Each of the light guiding fibers 1228 is extended from the light incident surface 1220 to the light emitting surface 1222. Cross section area of the light guiding fiber 1228 is constant (for example, diameters of the light guiding fiber 1228 from the light incident surface 1220 to the light emitting surface 1222 are constant). A projection of the light guiding channel 1226 on the light incident surface 1220 is overlapped with an edge of the light incident surface 1220. In other embodiments, the light guiding channels 1226 can be combined with a number of optical fibers, light guiding thin plates, silica fibers, glass fibers, or other light penetrating material.

The supporting portion 123 includes a bottom surface 1230 resisting with the non-display region 114, a first wall 1232 perpendicular to the bottom surface 1230, a second wall 1234 interconnecting the bottom surface 1203 and the first wall 1232. The second wall 1234 is coplanar to the first inclined surface 1224. Cross section area of the supporting portion 123 is an right triangle. In at least one embodiment, the supporting portion 123 is made of transparent material. The second wall 1234 is bonded with the first inclined surface 1224 via a colloid. In other embodiments, the supporting portion 123 is made of opacity metal or plastic material.

In detail, lights from the light incident surface 1220 provided by an image displayed on the display region 112 is guided to the light emitting surface 1222 by the light guiding channel 1226. When viewed from a direction perpendicular to the display panel 11, lights outputted by the light emitting surface 1222 related to lights provided to the light incident surface 1220 move a predetermine distance based on the inclined light guiding channels 1226. In other words, a position of an image outputted by the light emitting surface 1222 related to a position of a position of an image displayed by the display panel 11 moves the predetermined distance. The image outputted by the light emitting surface 1222 covers at least partial of the non-display region 114. The image displayed by the display panel 11 is an image displayed on the display region 112, or an image provided to the light incident surface 1220. In at least one embodiment, the position of the image outputted by the light emitting surface 1222 moves the predetermined distance towards to right direction of the display region 112. The predetermined distance is equal to a length of a projection of the light guiding channel 1226 on the light incident surface 1220, and is greater than or equal to a width of the non-display region 114 for completely covering the partial non-display region 114 located at one side of the display region 112 (for example, an area located on a right side of the display region 112). Based on the constant cross section of the light guiding channel 1226, the image provided to the light incident surface 12220 moves the predetermined distance to being outputted by the light emitting surface 1222 for preventing the image from being distorting, thus a display quality of the display 10 is stable. In other embodiments, the image outputted by the light emitting surface 1222 covers on partial of the non-display region 114 which is located at upper side of the display region 112. Thus, the non-display region 114 is partly invisible to a viewer. The display 10 has a zero border effect.

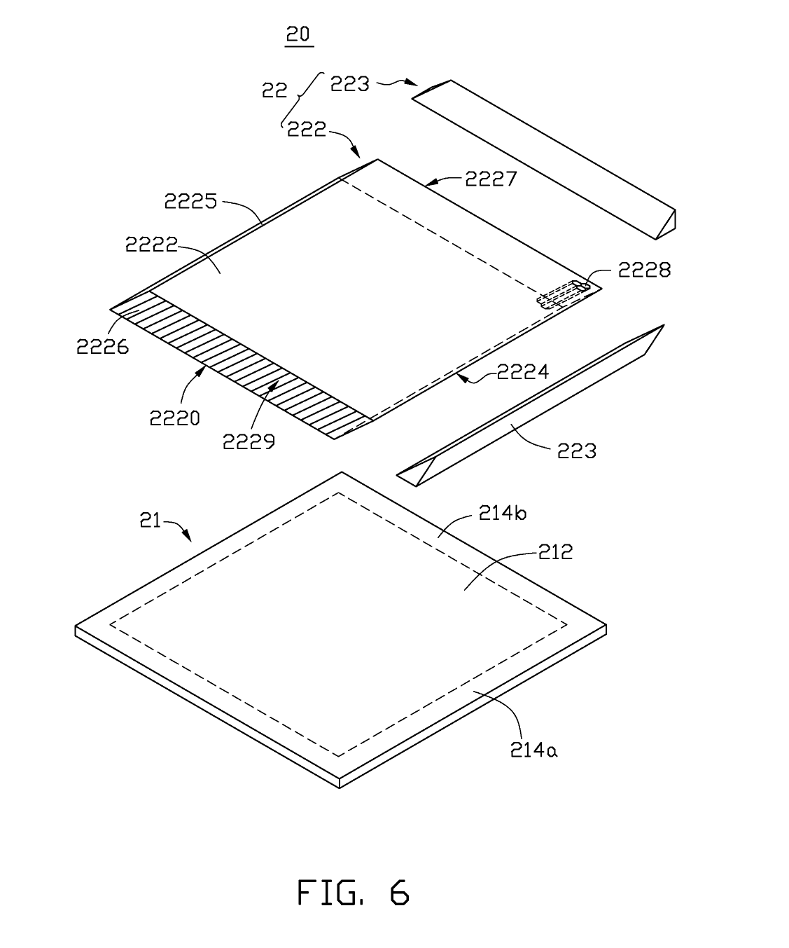

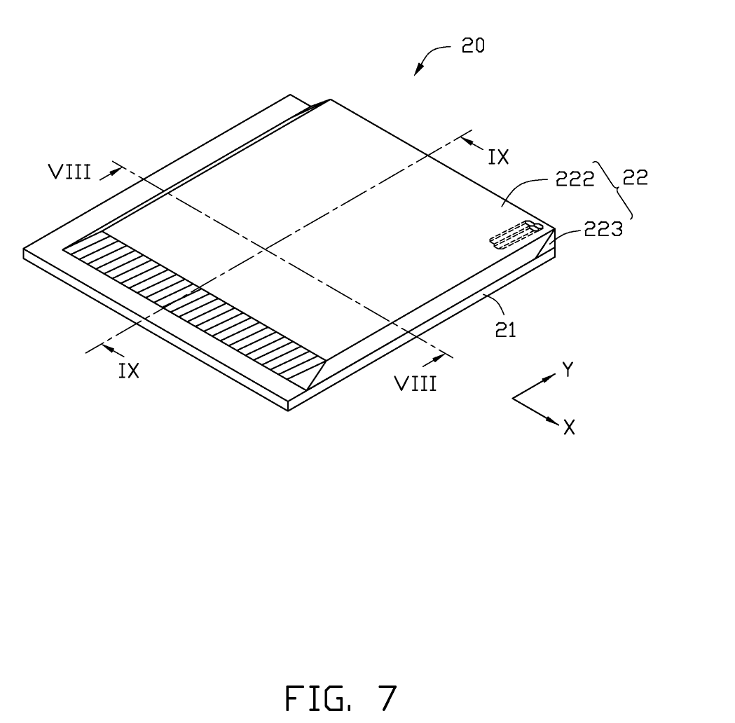

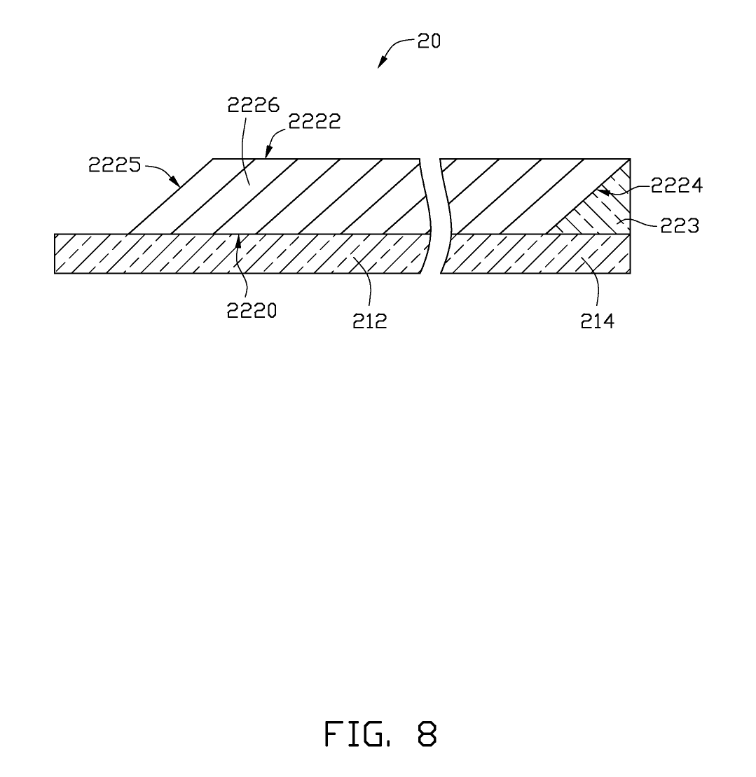

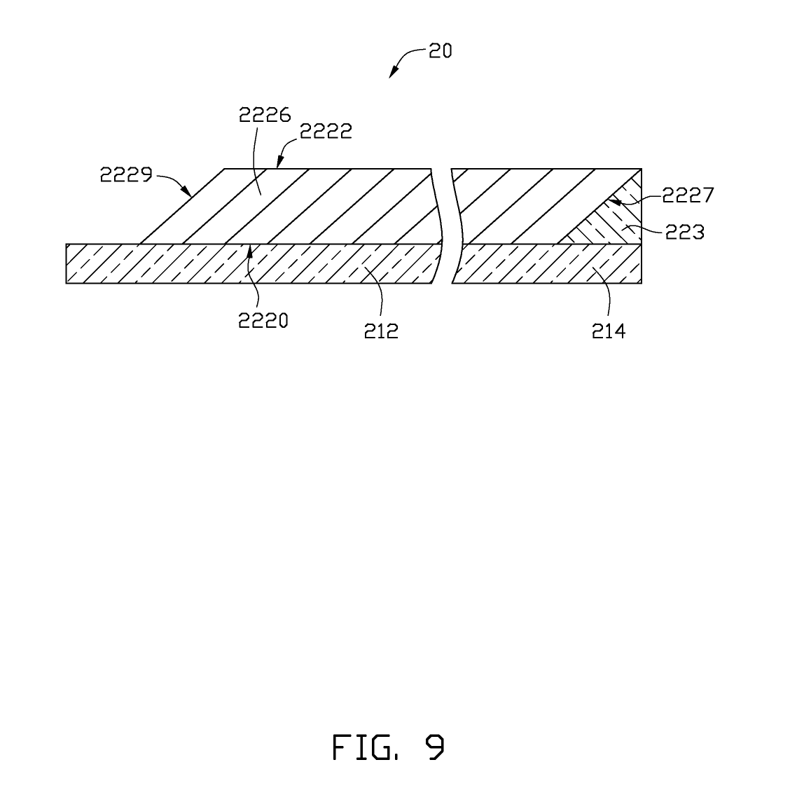

FIGS. 6-9 illustrate an another embodiment of the display 20. The image compensating portion 22 includes an image compensating portion 222, two supporting portions 223, and a plurality of light guiding channels 2226. The image compensating portion 222 is substantially hexahedron shaped. The image compensating portion 222 includes a light incident surface 2220, a light emitting surface 2222 parallel with the light incident surface 2220, a first inclined surface 2224, a second inclined surface 2225 parallel with the first inclined surface 2224, a third inclined surface 2227, and a fourth inclined surface 2229 parallel with the third inclined surface 2226. The first inclined surface 2224, the third inclined surface 2227, the second inclined surface 2225, and the fourth inclined surface 2229 are orderly extended from four edges of the incident surface 2220, and are interconnected the light emitting surface 2222. The third inclined surface 2227 and the fourth inclined surface 2229 are angled with the light incident surface 2220. The third inclined surface 2227 and the light incident surface 2220 may define an obtuse angle, which is within a range of 130 degrees to 150 degrees. The fourth inclined surface 2229 and the light incident surface 2220 may define an acute angle, which is within a range of 30 degrees to 50 degrees.

The supporting portions 223 are respectively corresponding to the first inclined surface 2224 and the third inclined surface 2227. The structure of the supporting portion 223 is same as the supporting portion 123. The extended direction of the light guiding channel 2226 is parallel with the first inclined surface 2224, the third inclined surface 2227, the second inclined surface 2225, and the fourth inclined surface 2229, and is different from the extended direction of the light guiding channel 1226. A projection of the light guiding channel 2226 is overlapped with a diagonal of the light incident surface 2220.

When viewed from a direction perpendicular to the display panel 21, a position of an image outputted by the light emitting surface 2222 related to an position of an image displayed by the display panel 21 moves a first predetermined distance along a direction X, and moves a second predetermined distance along a direction Y which is perpendicular to the direction X. The image displayed by the display panel 21 is an image displayed on the display region 212 or is an image provided to the light emitting surface 2222. The image outputted by the light emitting surface 2222 covers partial of the non-display region 214 which is located at a right side and the upper side of the display region 212. In at least one embodiment, the first predetermined distance is greater than or equal to a width of the non-display region 214a which is located at the right side of the display region 212, and the second predetermined distance is greater than or equal to a width of the non-display region 214b which is located at the upper side of the display region 212, the non-display region 214 located at the right side and the upper side area of the display region 212 is completely covered by the image outputted by the light emitting surface 2222. The image outputted by the light emitting surface 2222 is parallel with the image displayed by the display panel 11. Thus, the non-display region 114 is partly invisible to a viewer. The display 10 has a zero border effect.

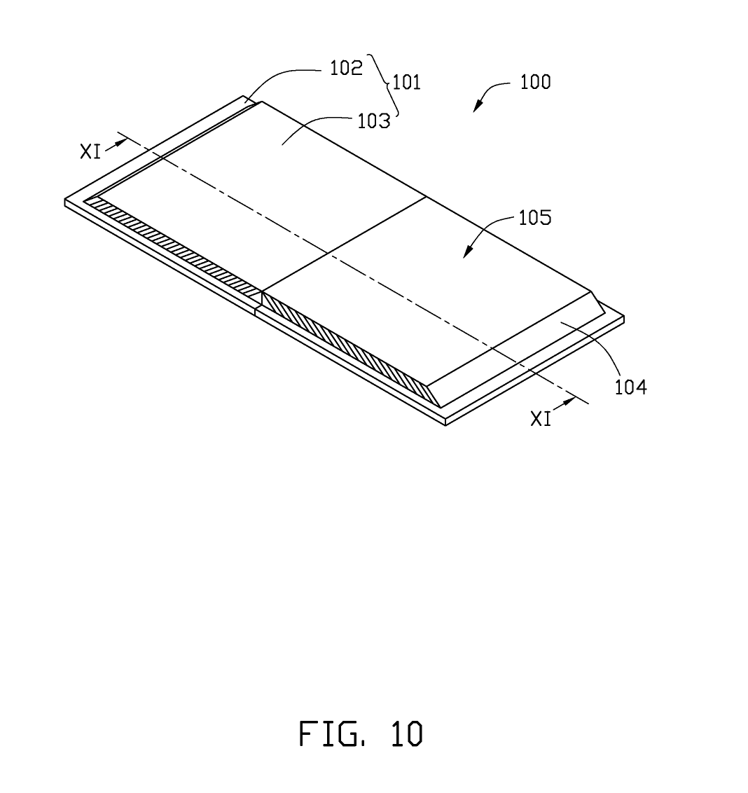

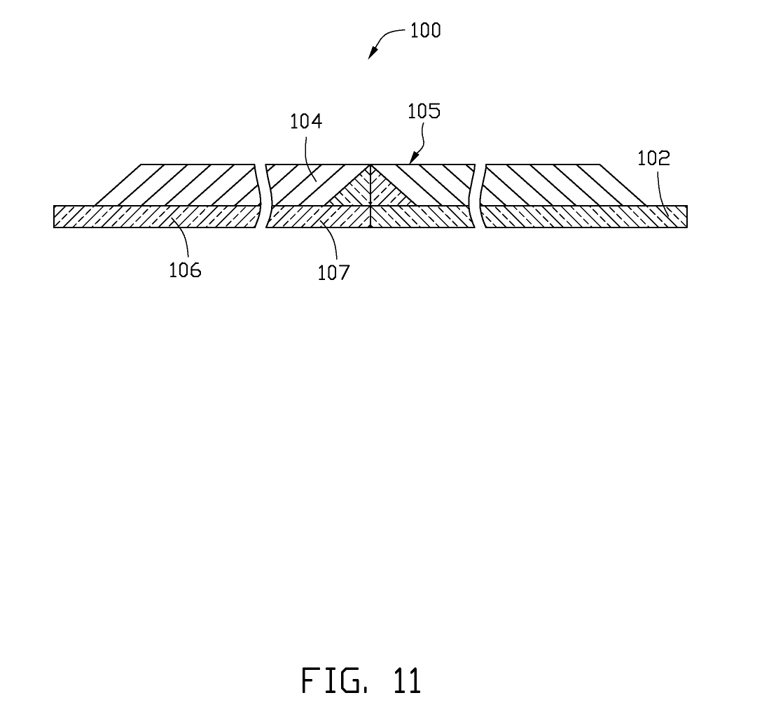

FIGS. 10 and 11 illustrates a display assembly 100 with two display 101 parallel with each other. The display 101 includes a display panel 102 and an image compensating portion 103. The structure of the display 101 is equal to the structure of the display 10. The non-display regions 107 forms a joint where the non-display regions 107 are connected. In assembly, the light emitting surface 105 of the displays 101 are interconnected for combining images outputted by the corresponding light emitting surface 105 together. A projection of the image compensating portion 104 on the display panel 102 is covered on the joint for keeping an image outputted by the image compensating portion 104 completely covering the joint. Thus, the non-display region 107 is invisible to a viewer. The display apparatus 100 has a zero border effect.

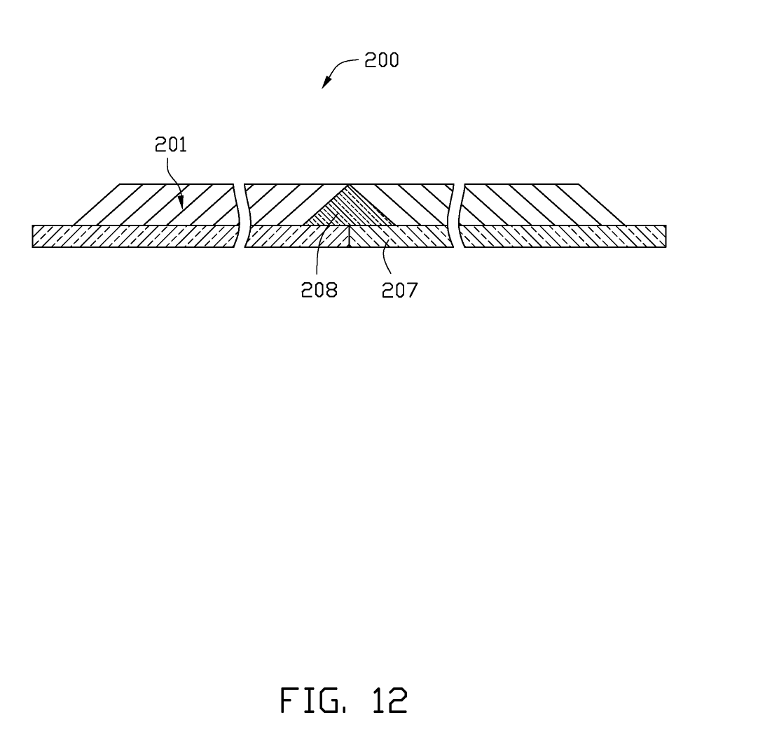

FIG. 12 illustrates the display assembly 200 with two displays 201. The supporting portions 208 of the display 201 are integrative configuration located on a joint of the non-display regions 207 of the displays 201.

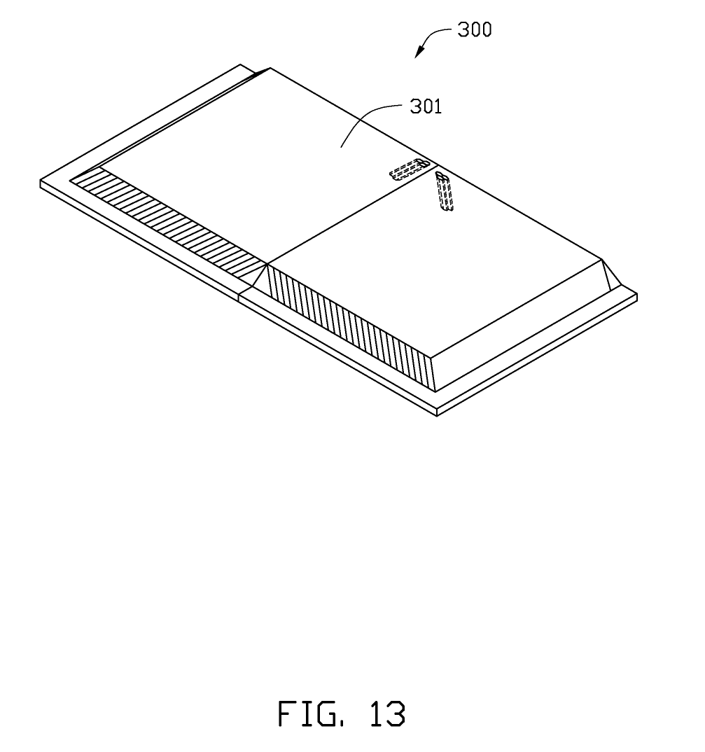

FIG. 13 illustrates the display assembly 300 with two displays 301. The supporting portions 223 of the displays 301 parallel with each other are jointed together. The structure of the display 301 is equal to the structure of the display 20.

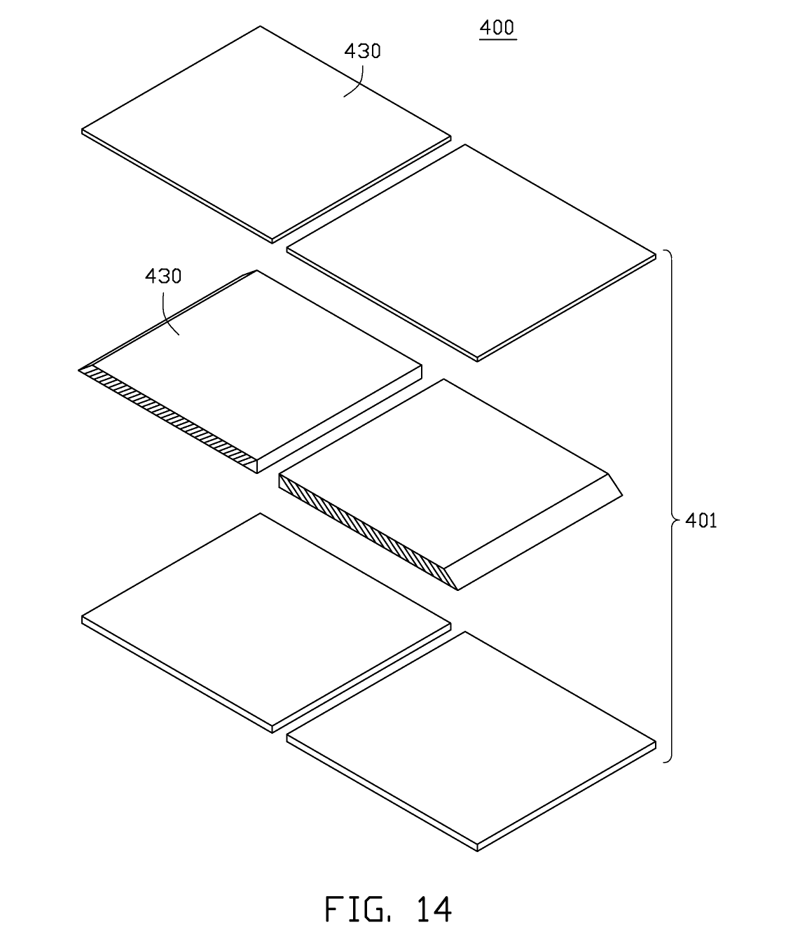

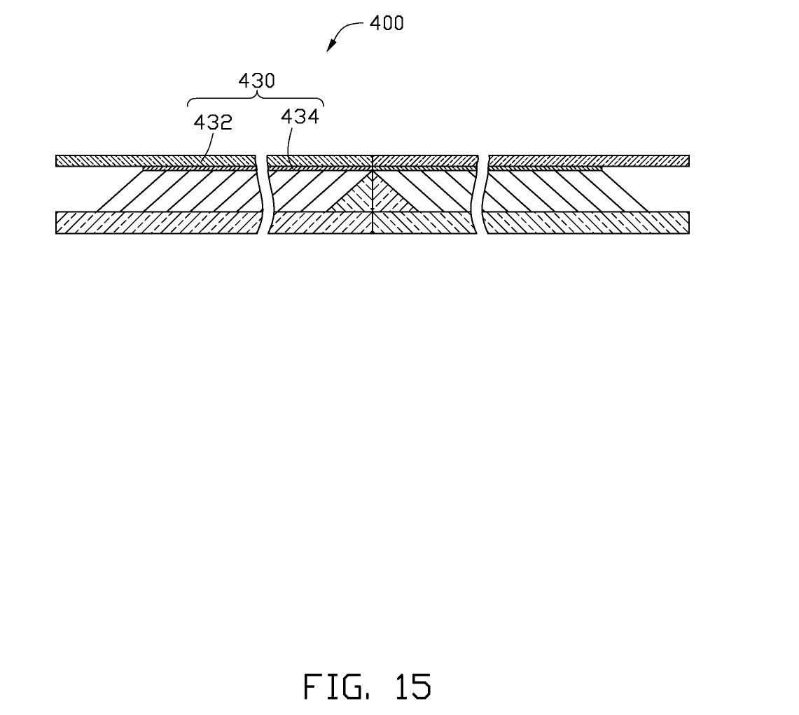

FIGS. 14 and 15 illustrate the display assembly 400 with two displays 401 and two image compensating apparatus 403. The display 401 further includes a cover 430 located on the image compensating apparatus 403. The two covers 430 are jointed together. The cover 430 includes a base 432 and a touch sensing structure 434 located on the base 432. The touch sensing structure 434 senses touch operations on the cover 430. In other embodiments, the two covers 430 are integrative configuration.

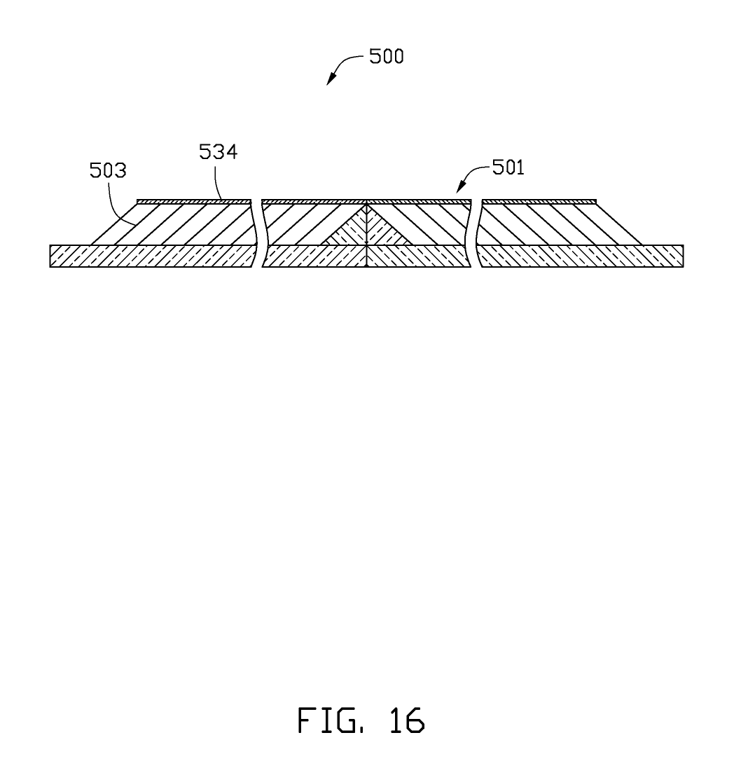

FIG. 16 illustrates the display assembly 500 with a display 501 which is similar to the display 101. The display 501 further includes a touch sensing structure 534 located on the image compensating portion 503. The touch sensing structure 534 senses touch operations on the display assembly 500.

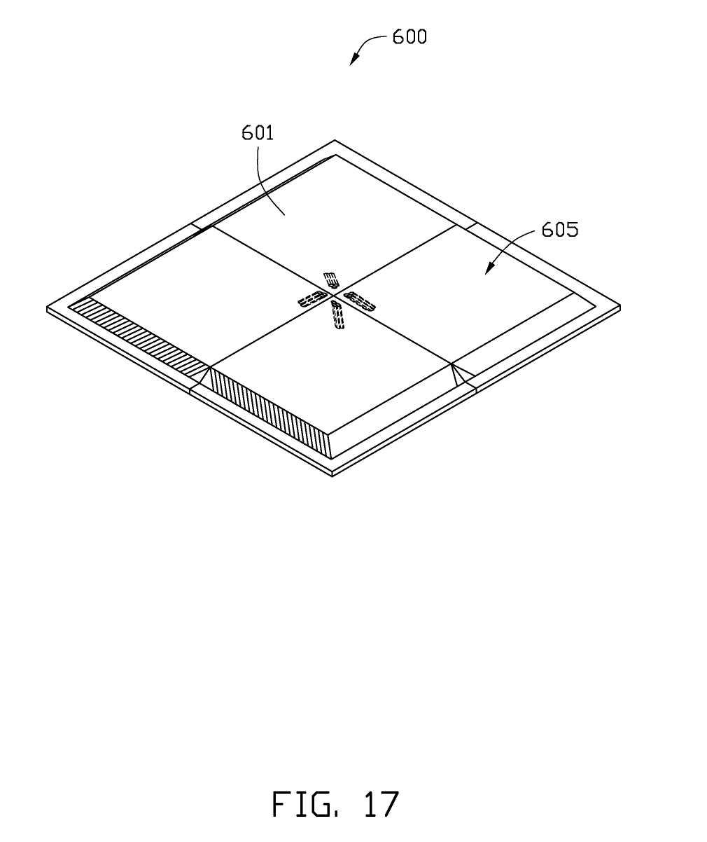

FIG. 17 illustrates the display assembly 600 with four displays 601 jointed together. The structure of the display 601 is same as the display 20. Light emitting surface 605 of each of the image compensating portion are jointed together for combining all images outputted by the light emitting surfaces 605 together.

In use, the image compensating apparatus 12 moves an image displayed on the display 10 for covering the non-display region 114, thus frames of the display 10 is invisible and the effect of the display 10 is improved

The embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims.

What is claimed is:

1. An image compensating apparatus located on a display panel, the display panel having a display region and a non-display region coupled to a periphery of the display region, the image compensating apparatus comprising:
an image compensating portion comprising a light incident surface resisting with the display region, a light emitting surface parallel with the light incident surface, and a plurality of light guiding channels parallel with each other;
wherein the light guiding channel is interconnected with the light incident surface;
the light emitting surface is extended from the light incident surface to the light emitting surface;
the light guiding channel and the light incident surface are defined an angle; and
the light incident surface is configured such that when viewed from a direction perpendicular thereto, an image rendered by the light emitting surface corresponding to the image displayed on the display region moves a predetermined distance to cover at least a portion of the non-display region.

2. The image compensating apparatus of claim 1, wherein a cross section of the light guiding channel is constant.

3. The image compensating apparatus of claim 1, wherein the defined angle is an acute angle within a range from 30 degrees to 50 degrees.

4. The image compensating apparatus of claim 1, wherein a projection of the light guiding channel on the light incident surface is overlapped with an edge of the light incident surface.

5. The image compensating apparatus of claim 1, wherein a projection of the light guiding channel on the light incident surface is overlapped with a diagonal of the light incident surface.

6. The image compensating apparatus of claim 1, wherein the image compensating portion further comprises a first inclined surface and a second inclined surface parallel with the first inclined surface; the first inclined surface and the light incident surface defines an obtuse angle within a range from 130 degrees to 150 degrees; the second inclined surface and the light incident surface define an acute angle within a range from 30 degrees to 50 degrees; the light guiding channel are parallel with the first inclined surface and the second inclined surface.

7. The image compensating apparatus of claim 6, wherein the image compensating portion further comprises a first connecting surface and a second connecting surface parallel with the first connecting surface; the first connecting surface and the second connecting surface are perpendicular to the light incident surface; the first inclined surface, the first connecting surface, the second inclined surface, and the second connecting surface are orderly extended from edges of the light incident surface, and are interconnected with the light emitting surface.

8. The image compensating apparatus of claim 6, wherein the image compensating portion further comprises a third inclined surface and a fourth inclined surface parallel with the first connecting surface; the third inclined surface and the light incident surface defines an obtuse angle within a range from 130 degrees to 150 degrees; the fourth inclined surface and the light incident surface define an acute angle within a range from 30 degrees to 50 degrees; the light guiding channel are parallel with the third inclined surface and the fourth inclined surface; the first inclined surface, the third inclined surface, the second inclined surface, and the fourth inclined surface are orderly extended from opposite edges of the light incident surface, and are interconnected with the light emitting surface.

9. A display assembly comprising:
at least two displays arranged in parallel;
wherein each of the displays comprises a display panel with a display region and a non-display region connecting a periphery of the display region; at least one of the displays comprises an image compensating apparatus; the image compensating apparatus comprises a light incident surface resisting with the corresponding display region, a light emitting surface parallel with the light incident surface, and a plurality of light guiding channels parallel with each other; the light guiding channel interconnected with the light incident surface and the light emitting surface is extended from the light incident surface to the light emitting surface, the light guiding channel and the light incident surface are defined an angle; when viewed from a direction perpendicular to the light incident surface, an image outputted by the light emitting surface related to the image displayed on the display region moves in a predetermined distance for covering at least partial of the corresponding non-display region.

10. The display assembly of claim 9, wherein the display assembly comprises four displays jointed together, each of the display comprises an image compensating apparatus; each of the display further comprises a supporting portion set on the corresponding non-display region; the supporting portions are integrative configuration; the light emitting surface of each of the image compensating apparatus are jointed together for combining all images outputted by the light emitting surfaces together.

11. The display assembly of claim 9, wherein each of the displays comprises an image compensating apparatus; the light emitting surfaces of the displays are interconnected for combining images outputted by the corresponding light emitting surface together.

12. The display assembly of claim 9, wherein each of the displays comprises an image compensating apparatus; the light emitting surfaces of the displays are interconnected for combining images outputted by the corresponding light emitting surface together.

13. The display assembly of claim 9, wherein a joint is formed where the non-display regions are connected; a projection of each of the image compensating portion on the corresponding display region is covered on the joint for keeping an image outputted by the image compensating portion completely covers the joint.

14. The display assembly of claim 9, wherein a projection of the light guiding channel on the light incident surface is overlapped with an edge of the light incident surface.

15. The display assembly of claim 9, wherein a cross section of the light guiding channel is constant, and the defined angle is an acute angle within a range from 30 degrees to 50 degrees.

16. The display assembly of claim 9, wherein each of the displays further comprises a cover; the cover located on the corresponding image compensating apparatus; the cover comprises a base and a touch sensing structure located on the base; the touch sensing structure senses touch operations on the cover.

17. The display assembly of claim 9, wherein each of the displays further comprise a touch sensing structure located on the image compensating apparatus; the touch sensing structure senses touch operations on the display assembly.

18. The display assembly of claim 9, wherein the image compensating portion further comprises a first inclined surface and a second inclined surface parallel with the first inclined surface; the first inclined surface and the light incident surface defines an obtuse angle within a range from 130 degrees to 150 degrees; the second inclined surface and the light incident surface define an acute angle within a range from 30 degrees to 50 degrees; the light guiding channel are parallel with the first inclined surface and the second inclined surface.

19. The display assembly of claim 18, wherein the image compensating portion further comprises a first connecting surface and a second connecting surface parallel with the first connecting surface; the first connecting surface and the second connecting surface are perpendicular to the light incident surface; the first inclined surface, the first connecting surface, the second inclined surface, and the second connecting surface are orderly extended from edges of the light incident surface, and are interconnected with the light emitting surface.

20. The display assembly of claim 18, wherein the image compensating portion further comprises a third inclined surface and a fourth inclined surface parallel with the first connecting surface; the third inclined surface and the light incident surface defines an obtuse angle within a range from 130 degrees to 150 degrees; the fourth inclined surface and the light incident surface define an acute angle within a range from 30 degrees to 50 degrees; the light guiding channel are parallel with the third inclined surface and the fourth inclined surface; the first inclined surface, the third inclined surface, the second inclined surface, and the fourth inclined surface are orderly extended from opposite edges of the light incident surface, and are interconnected with the light emitting surface.
